(19) United States
(12) Patent Application Publication
(10) Pub. No.: US 2024/0297470 A1
(43) Pub. Date: Sep. 5, 2024

(54) DOCKING SYSTEM FOR CONNECTING ELECTRONIC DEVICES

(71) Applicant: TARGUS INTERNATIONAL LLC, Anaheim, CA (US)

(72) Inventors: Man Cheung Dan Tsang, Carlsbad, CA (US); Ronald DeCamp, Long Beach, CA (US)

(21) Appl. No.: 17/934,739

(22) Filed: Sep. 23, 2022

(51) Int. Cl. H01R 33/97; G06F 1/16; H01R 35/04

(52) U.S. Cl. CPC H01R 33/97; G06F 1/1632; H01R 35/04

(57) ABSTRACT

Docking systems for electronic devices including displays are disclosed. An example docking system includes a first housing, a port hub and an integrated or detachable holder. The first housing includes a first surface that receives a first device, a second surface opposite to the first surface and a pad disposed on the second surface at proximity to a side of the second surface. The port hub may include a power inlet and a data input/output port. The power inlet receives a power supply voltage and further provides the power supply voltage to the first device. The data input/output port may receive data signals and may further provide the received data signals to the first device. The holder securing a second housing to the pad may include a hinge that pivotally adjusts an angle between the first housing and the second housing. The second housing may receive a second device.

### BACKGROUND

This disclosure generally relates to a docking system including electronic apparatuses, and, more specifically, display devices and connectors.

### BRIEF DESCRIPTION OF THE DRAWINGS

FIG. 1 illustrates a front view of an exemplary docking system according to an embodiment of the present disclosure.

FIG. 2 illustrates a back view of an exemplary docking system according to an embodiment of the present disclosure.

FIG. 3 illustrates an apparatus including a holder of the exemplary docking system according to an embodiment of the present disclosure.

FIG. 4 illustrates a back view of an exemplary docking system according to an embodiment of the present disclosure.

FIG. 5 illustrates a perspective view of housings according to an embodiment of the present disclosure.

FIG. 6 illustrates a perspective view of a holder of an exemplary docking system according to the embodiment of the present disclosure.

FIGS. 7A and 7B illustrate perspective views of a housing according to an embodiment of the present disclosure.

FIG. 7C illustrates a side view of the housing according to the embodiment of the present disclosure.

FIG. 7D illustrates a side view of a housing according to an embodiment of the present disclosure.

FIGS. 7E and 7F illustrate perspective views of housings according to an embodiment of the present disclosure.

FIG. 8A illustrates a back view of housings according to an embodiment of the present disclosure.

FIGS. 8B and 8C illustrate a pad and a housing according to the embodiment of the present disclosure.

FIG. 9 illustrates a pad and a housing to an embodiment of the present disclosure.

### DETAILED DESCRIPTION

Various embodiments of the present disclosure will be explained below in detail with reference to the accompanying drawings. The following detailed description refers to the accompanying drawings that show, by way of illustration, specific aspects and embodiments of the disclosure. The detailed description includes sufficient detail to enable those skilled in the art to practice the embodiments of the disclosure. Other embodiments may be utilized, and structural, logical, and electrical changes may be made without departing from the scope of the present disclosure. The various embodiments disclosed herein are not necessary mutually exclusive, as some disclosed embodiments can be combined with one or more other disclosed embodiments to form new embodiments. Thus, the following more detailed description of the embodiments of the systems, methods, and apparatuses is not intended to limit the scope of the disclosure, but is merely representative of possible embodiments of the disclosure. In some cases, well-known structures, materials, or operations are not shown or described in detail.

The present disclosure provides various embodiments of docking systems including a housing with a pad and a holder. According to various embodiments, a holder may securely attach an auxiliary device to a docking system integrating an electronic device, such as a display, on a pad on a back surface at proximity to a side (e.g., an edge) of the back surface. In some embodiments, the holder may include a clamp that securely and physically couples the auxiliary device to the electronic device. In some embodiments, the holder may include a hinge that may pivotally adjust an angle between the auxiliary device and the electronic device. The holder may include a protuberance and the docking system may receive the protuberance at the pad. By including the pad and the holder, the holder may securely and physically couple the auxiliary device to the pad of the electronic device.

Furthermore, in some embodiments, the protuberance may include a plug, and the pad comprises a port that may receive the plug. In some embodiments, either the docking system or the holder may include a connection plug, and either the holder or the docking system may include a connection port, respectively. By including the plug and the port, the holder may securely and electrically couple the auxiliary device to the electronic device to provide wired power and signal transmissions directly without redundant cables and wires around the devices, not relying on wireless communications.

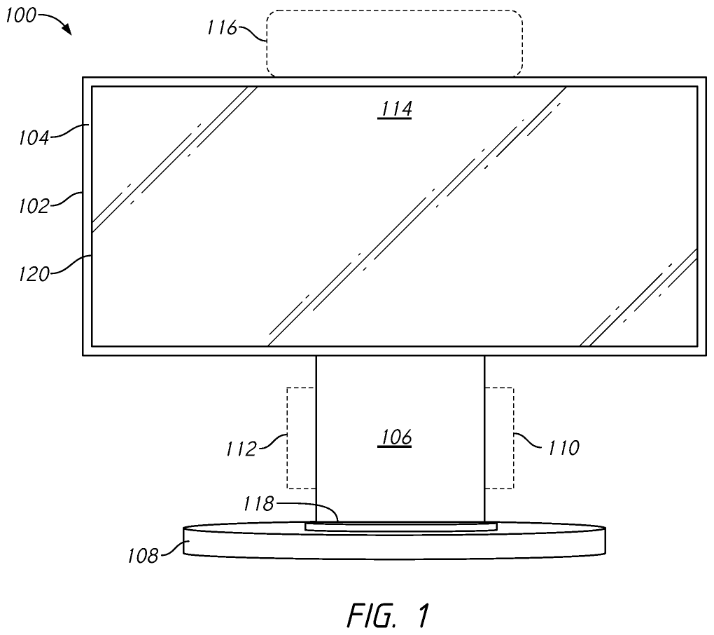

FIG. 1 illustrates a front view of an exemplary docking system 100 according to an embodiment of the present disclosure. In some embodiments, the docking system 100 may include a housing 102, an arm 106, and a base 108.

The base 108 may by shaped as, for example, a circle, an oval, a rectangle, or any other feasible shape, with at least one planar surface on the bottom of the base 108, in a manner that the base 108 may be placed on another surface, such as a desk or table. In some embodiments, the base 108 may include another planar surface on top of the base 108. In some embodiments, the base 108 may include a charger 118 that is configured to wirelessly charge a battery in an electronic device placed on the base 108.

The arm 106 has an end securely placed on the base 108 and another end securely attached to the housing 102. The arm 106 and the base 108 together support the housing 102 to be positioned above the desk. In some embodiments, a port hub 110 may be securely attached to a side of the arm 106. In some embodiments, the port hub 110 may be integrated into the side of the arm 106. For example, the port hub 110 may include one or more data ports compliant with Universal Serial Bus (USB) Type-A, USB Type-B, USB Type-C, DisplayPort (DP), mini DP, an audio port, etc. In some embodiments, one or more sensors 112, such as a microphone, gesture sensors, etc. may be securely attached to a side of the arm 106. In some embodiments, the sensors 112 may be integrated into the side of the arm 106.

The housing 102 may include a front surface 104. In some embodiments, the front surface 104 may have an opening 120. In some embodiments, an electronic device 114 may be encased in the opening 120. In some embodiments, the electronic device 114 may be a display. That the electronic device 114 uses the display is given by way of example and not by limitation. The electronic device 114 may instead include a tablet, a smartphone, a portable personal computer, one or more speakers, or any other electronic device that has been coupled with the housing 102 having an appropriate opening 120. In some embodiments, an auxiliary device 116 may be securely attached to an outer side of the housing 102, such as a top, left, or right side of the housing 102. In some embodiments, the auxiliary device 116 may include an electronic device, such as a camera, a microphone, a speaker, or any combination thereof. In some embodiments, the auxiliary device 116 may include a light, such as a light emitting diode (LED) that may assist visibility around the housing 102 and/or an object captured by the camera.

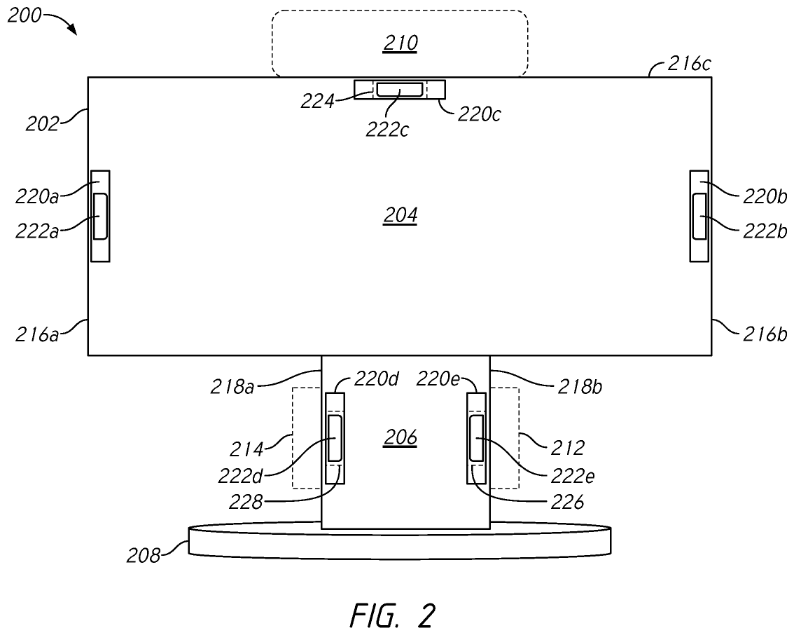

FIG. 2 illustrates a back view of an exemplary docking system 200 according to an embodiment of the present disclosure. In some embodiments, the docking system 200 may be the docking system 100. The docking system 200 may include a housing 202, an arm 206, and a base 208. In some embodiments, the housing 202, the arm 206, and the base 208 may be the housing 102, the arm 106, and the base 108, respectively. The housing 202, the arm 206, and the base 208 may include any of the features of the housing 102, the arm 106, and the base 108, and vice versa, respectively. Thus, detailed description of structures of the housing 202, the arm 206, and the base 208 that have been previously described referring to the housing 102, the arm 106, and the base 108 is therefore not repeated herein for brevity.

The housing 202 may have sides, including a left side 216a, a right side 216b, and a top side 216c. The housing 202 may include a back surface 204 opposite to a front surface, such as the front surface 104. In some embodiments, the housing 202 may include pads 220a, 220b, and 220c disposed on the back surface 204. The pads 220a, 220b, and 220c may be disposed at proximate to the left side 216a, the right side 216b, and the top side 216c, respectively. An auxiliary device 210, such as the auxiliary device 116, may be securely attached to any side of the housing 202, such as the left side 216a, the right side 216b, or the top side 216c of the housing 202. In some embodiments, the auxiliary device 210 may include a holder 224 that may securely attach the auxiliary device 210 to any of the pads 220a, 220b, or 220c. In some embodiments, the auxiliary device 210 may be encased in a housing (not shown) that receives the auxiliary device 210. In some embodiments, the holder 224 may be integrated into the housing 202.

The arm 206 may have sides, including a left side 218a and a right side 218b extending between the housing 202 and the base 208. In some embodiments, the arm 206 may include pads 220d and 220e. The pads 220d and 220e may be disposed at proximate to the left side 218a and the right side 218b, respectively. In some embodiments, a port hub 212, such as the port hub 110, may be securely attached to the left side 218a or the right side 218b of the arm 206. In some embodiments, one or more sensors 214, such as the sensors 112, may be securely attached to the left side 218a or the right side 218b of the arm 206. In some embodiments, the port hub 212 and the sensors 214 may include holders 226 and 228, respectively. The holder 226 and/or the holder 228 may securely attach the port hub 212 and/or the sensors 214 to any of the pad 220e and/or the pad 220d. In some embodiments, the port hub 212 and/or the sensors 214 may be encased in respective housings (not shown). In some embodiments, the holder 226 may be integrated into the housing of the port hub 212, and the holder 228 may be integrated into the housing of the sensors 214.

In some embodiments, the holder 224 may be a clamp that may hold a side, such as the left side 216a, the right side 216b, or the top side 216c. In some embodiments, each of the holders 226 and 228 may be a clamp that may hold a side, such as each of the sides 218b and 218a, respectively. For example, the holder 224 may be a clamp that may hold a side, such as the side 216a, 216b, or 216c, in a manner that the holder 224 may securely attach the auxiliary device 210 to the pad 220a, 220b, or 220c. Each of the holders 228 and 226 may hold a side, such as each of the sides 218a and 218b, in a manner that each of the holders 228 and 226 may securely attach the sensors 214 and the port hub 212 to the pads 220d and 220e, respectively.

In some embodiments, each of the holders 224, 226, and 228 may include a protuberance. Each of the pads 220a-220e may be configured to securely receive the protuberance of each of the holders 224, 228, and 226. In some embodiments, each of the pads 220a-220e may include a recess that may receive the protuberance of each of the holders 224, 226, and 228 in a manner that the protuberance of each of the holders 224, 226, and 228 may be fitted into the recess of each of the pads 220a-220e.

In some embodiments, the protuberance of each of the holders 224, 226, and 228 may include a piece of magnet and each of the pads 220a-220e may include metal. Attraction between the piece of magnet in the protuberance of each of the holders 224, 226, and 228 and each of the pads 220a-220e may further support securely attaching the auxiliary device 210, the port hub 212, and/or the sensors 214 to the pads 220a-220e.

In some embodiments, each of the holders 224, 226, and 228 may include one or more pins and each of the pads 220a-220e may include corresponding one or more holes to receive the one or more pins. In some embodiments, each of the pads 220a-220e may include one or more pins and each of the holders 224, 226, and 228 may include corresponding one or more holes to receive the one or more pins. The one or more pins and the corresponding one or more holes may further support securely attaching the auxiliary device 210, the port hub 212, and/or the sensors 214 to the pads 220a-220e.

In some embodiments, the protuberance of each of the holders 224, 226, and 228 may include a plug. The recesses of the pads 220a-220e may be ports 222a-222e that are able to receive the plug of each of the holders 224, 226, and 228. In some embodiments, the plug may be a power plug and the port may be a power outlet and/or a power inlet. In some embodiments, the power outlet of each of the pads 220a-220e and the plug of each of the holders 224, 226, and 228 may provide a power supply voltage from the docking system 200 to the auxiliary device 210, the port hub 212, and/or the sensor 214. In some embodiments, the plug of each of the holders 224, 226, and 228 and the power inlet of each of the pads 220a -220e may provide a power supply voltage from the auxiliary device 210 and/or the port hub 212 to the docking system 200. In some embodiments, the plug may be a data connector, including one or more data pins, and the port may be a data input/output port. In some embodiments, the port of each of the pads 220a-220e and the data connector of each of the holders 224, 226, and 228 may transmit one or more data signals between the docking system 200 to the auxiliary device 210, the port hub 212, and/or the sensor 214 in a bidirectional manner. The data signals may include, for example, a video signal, an audio signal, and/or a control signal. In some embodiments, the plug and the port may provide power and data both. For example, the data connector and the data input/output port may be compliant with High-Definition Multimedia Interface (HDMI), Universal Serial Bus (USB) Type-A, USB Type-B, USB Type-C, DisplayPort (DP), mini DP, etc.

As described above, a docking system including a housing and/or an arm with ports together with a holder with plugs that couple to an auxiliary device to an electronic device encased in the housing provides a direct and secure electrical and physical coupling of the devices without redundant cables and wires around the devices.

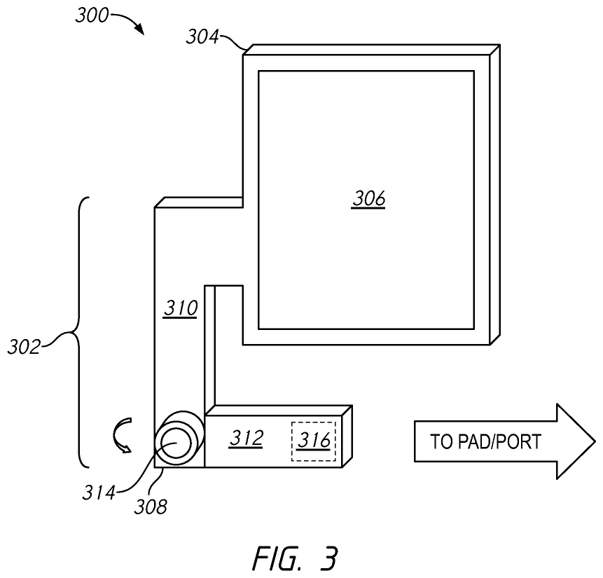

FIG. 3 illustrates an apparatus 300 including a holder 302 of the exemplary docking system 200 according to an embodiment of the present disclosure. The apparatus 300 may include the holder 302 and a housing 304 that may receive a device 306. In some embodiments, the device 306 may be an electronic device, such as the auxiliary device 116 or the auxiliary device 210. The holder 302 may include arms 310 and 312 and a hinge 308 that couples the arms 310 and 312. The arms 310 and 312 may pivotally move around a pin 314 of the hinge 308. The hinge 308 may pivotally adjust an angle between the arms 310 and 312.

In some embodiments, the apparatus 300 may be a clamp that includes the holder 302 and the housing 304. Because the hinge 308 may pivotally adjust the angle between the arms 310 and 312, the clamp may control a distance between the housing 304 and the arm 312. Thus, the holder 302 may securely hold a side, such as the side 216a, 216b, 216c, 218a, or 218b, of a housing of a docking system, such as the housing 202 of the docking system 200, in a manner that the holder 302 may securely attach the device 306 to a pad of the docking system, such as the pad 220a, 220b, 220c, 220d, or 220e.

In some embodiments, the arm 310 may have an end connected to the hinge 308 and another end opposite to the end connected to the housing 304. The arm 312 may have an end connected to the hinge 308 and another end opposite to the end that may be in contact with a pad of the docking system 200, such as the pad 220a, 220b, 220c, 220d, or 220e.

In some embodiments, the arm 312 may include a protuberance. In some embodiments, an end of the arm 312 in contact with the pad is the protuberance. In some embodiments, the arm 312 and the pad in contact with the arm 312 may further include supporting components to assist the secure attachment. For example, the other end of the arm 312 in contact with the pad of the docking system 200 may include a magnet 316. In some embodiments, the other end of the arm 312 may be magnetically attracted to the pad of the docking system 200 that includes ferromagnetic metal. For another example, either the arm 312 or the pad may further include a pin (not shown), and either the pad or the arm 312 may further include a hole that receives the pin, respectively.

In some embodiments, the protuberance of the arm 312 may further include plugs (not shown). The plugs may include pins that may be received by any of the ports 222a-222e. In some embodiments, the arm 312 may further include one or more ports that receive plugs. The pads 220a-220e may include plugs that may be received by the one or more ports of the arm 312. In some embodiments, the plug may be a power plug and the port may be a power outlet or a power inlet. In some embodiments, the power outlet of each of the pads 220a-220e and the plug of the arm 312 may provide a power supply voltage from the docking system 200 to the device 306. In some embodiments, the plug of the arm 312 and the power inlet of each of the pads 220a-220e may provide a power supply voltage from the device 306 to the docking system 200. In some embodiments, the plug may be a data connector, including one or more data pins, and the port may be a data input/output port. In some embodiments, the port of each of the pads 220a-220e and the data connector of the arm 312 may transmit one or more data signals between the docking system 200 to the device 306 in a bidirectional manner. The data signals may include, for example, a video signal, an audio signal, and/or a control signal. In some embodiments, the plug and the port may transmit power and data both. For example, the data connector and the data input/output port may be compliant with High-Definition Multimedia Interface (HDMI), Universal Serial Bus (USB) Type-A, USB Type-B, USB Type-C, DisplayPort (DP), mini DP, etc.

As described above, a docking system including a housing and/or an arm with ports together with a holder with plugs that couple to an auxiliary device to an electronic device encased in the housing provides a direct and secure electrical and physical coupling of the devices without redundant cables and wires around the devices.

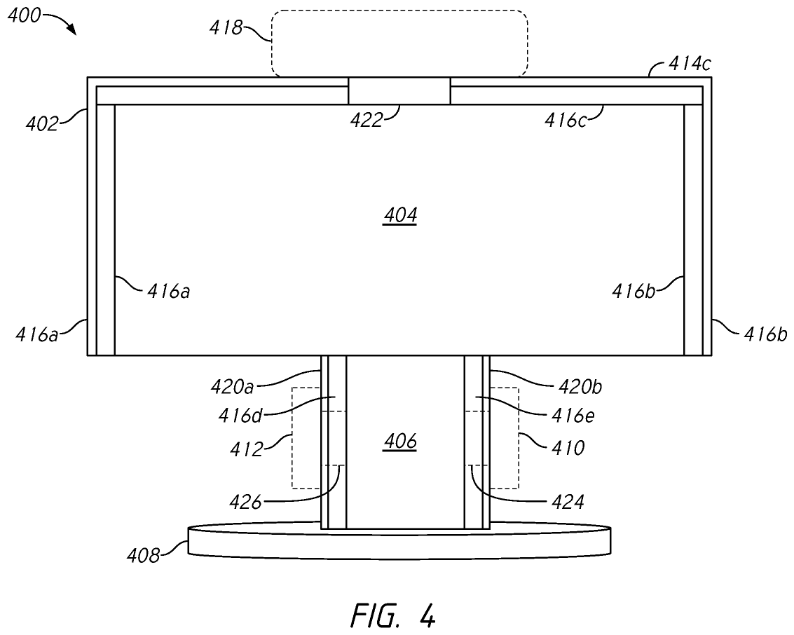

FIG. 4 illustrates a back view of an exemplary docking system 400 according to an embodiment of the present disclosure. In some embodiments, the docking system 400 may be the docking system 100. The docking system 400 may include a housing 402, an arm 406, and a base 408. In some embodiments, the housing 402, the arm 406, and the base 408 may be the housing 102, the arm 106, and the base 108, respectively. The housing 402, the arm 406, and the base 408 may include any of the features of the housing 102, the arm 106, and the base 108, and vice versa, respectively. Thus, detailed description of structures of the housing 402, the arm 406, and the base 408 may that have been previously described referring to the housing 102, the arm 106, and the base 108 is therefore not repeated herein for brevity.

The housing 402 may have sides, including a left side 414a, a right side 414b, and a top side 414c. The housing 402 may include a back surface 404 opposite to a front surface, such as the front surface 104. In some embodiments, the housing 402 may include pads 416a, 416b, and 416c disposed on the back surface 404. The pads 416a, 416b, and 416c may be disposed at proximate to the left side 414a, the right side 414b, and the top side 414c, respectively. In some embodiments, the pads 416a, 416b, and 416c may extend along the left side 414a, the right side 414b, and the top side 414c, respectively. In some embodiments, each of the pads 416a, 416b, and 416c may have an elongated shape along the proximate side. For example, the pads 416a, 416b, and 416c may be strips. In some embodiments, each of the pads 416a, 416b, and 416c may be provided in an elongated recess on the back surface 404. Elongated recesses may be disposed along each of the left side 414a, the right side 414b, and the top side 414c, respectively.

An auxiliary device 418, such as the auxiliary device 116, may be securely attached flexibly to any portion of any side of the housing 402, such as one end, the other end, or anywhere between the ends of the left side 414a, the right side 414b, or the top side 414c of the housing 402. In some embodiments, the auxiliary device 418 may include a holder 422 that may securely attach the auxiliary device 418 to any of the pads 416a, 416b, and 416c. In some embodiments, the auxiliary device 418 may be encased in a housing (not shown) that receives the auxiliary device 418. In some embodiments, the holder 422 may be integrated into the housing 402.

The arm 406 may have sides, including a left side 420a and a right side 420b, extending between the housing 402 and the base 408. In some embodiments, the arm 406 may include pads 416d and 416e. The pads 416d and 416e may be disposed at proximate to the left side 420a and the right side 420b, respectively. In some embodiments, the pads 416d and 416e may extend along the left side 420a and the right side 420b, respectively. In some embodiments, each of the pads 416d and 416e may have an elongated shape along the proximate side. For example, the pads 416d and 416e may be strips. In some embodiments, each of the pads 416d and 416e may be provided in an elongated recess disposed along each of the left side 420a and the right side 420b, respectively.

In some embodiments, a port hub 410, such as the port hub 110, may be securely attached to the left side 420a or the right side 420b of the arm 406. In some embodiments, one or more sensors 412, such as the sensors 112, may be securely attached to the left side 420a or the right side 420b of the arm 406. In some embodiments, the port hub 410 and the sensors 412 may include holders 426 and 424, respectively. The holder 426 and/or the holder 424 may securely attach the port hub 410 and/or the sensors 412 to any of the pad 416d and/or the pad 416e. In some embodiments, the port hub 410 and/or the sensors 412 may be encased in respective housings (not shown). In some embodiments, the holder 426 may be integrated into the housing of the port hub 410, and the holder 424 may be integrated into the housing of the sensors 412.

In some embodiments, the holder 422 may be a clamp that may hold a side, such as the left side 414a, the right side 414b, and the top side 414c. In some embodiments, each of the holders 426 and 424 may be a clamp that may hold a side, such as each of the sides 420a and 420b. For example, the holder 422 may be a clamp that may hold a side, such as the side 414a, 414b, or 414c in a manner that the holder 422 may securely attach the auxiliary device 418 to any portion of the pad 416a, 416b, or 416c. Each of the holders 424 and 426 may hold a side, such as each of the sides 420a and 420b, in a manner that each of the holders 424 and 426 may securely attach the sensors 412 and the port hub 410 to any portion of the pads 416d and 416e, respectively.

In some embodiments, each of the holders 422, 424, and 426 may include a piece of magnet, such as the magnet 316. In some embodiments, each of the pads 416a-416e may include metal. The piece of magnet in the holder 422 may be attracted to any portion of any side of the housing 402, such as one end, the other end, or anywhere between the ends of the left side 414a, the right side 414b, or the top side 414c of the housing 402. The piece of magnet in each of the holders 426 and 424 may be attracted to any portion of any side of the arm 406, such as one end, the other end, or anywhere between the ends of the left side 420a or the right side 420b of the arm 406, respectively. Attraction between the piece of magnet in each of the holders 422, 424, and 426 and each of the pads 416a-416e may further support securely attaching the auxiliary device 418, the port hub 410, and/or the sensors 412 to the pads 416a-416e.

As described above, a docking system including a housing and/or an arm with pads extending along sides of the housing and/or the arm together with a holder that couples to an auxiliary device to an electronic device encased in the housing provides secure and flexible physical coupling of the devices without specific attaching locations around the housing of the electronic device.

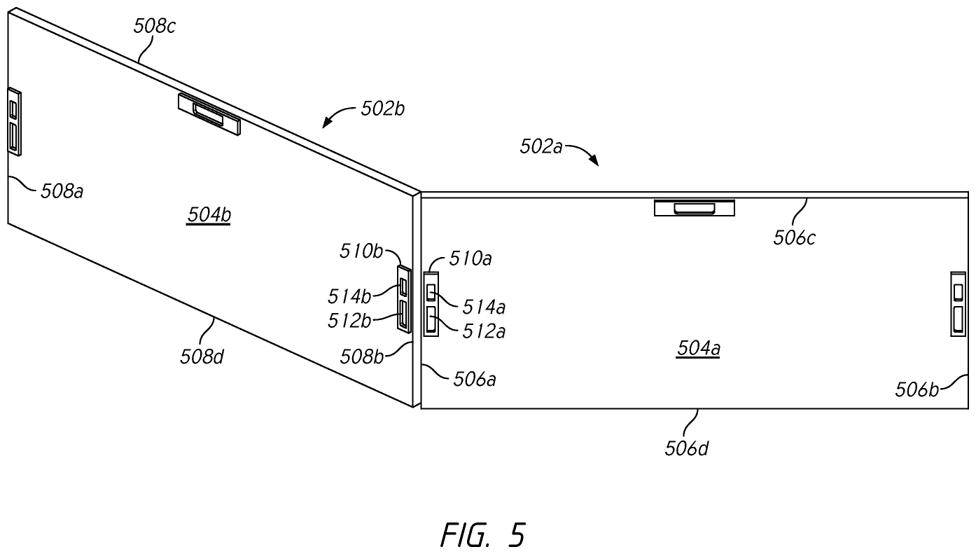

In some embodiments, two or more adjacent docking systems may be coupled closely to provide a close connection of adjacent electronic devices encased in the docking systems. FIG. 5 illustrates a perspective view of housings 502a and 502b of two adjacent docking systems according to an embodiment of the present disclosure. In some embodiments, the housings 502a and 502b may be the housing 102 of FIG. 1. Thus, detailed description of structures of the housings 502a and 502b that have been previously described referring to the housing 102 is therefore not repeated herein for brevity.

In some embodiments, the housing 502a includes a back surface 504a having a rectangle shape. The back surface 504a may have a side 506a adjacent to the back surface 504b, another side 506b opposite to the side 506a, a top side 506c, and a bottom side 506d. In some embodiments, the housing 502b includes a back surface 504b having a rectangle shape. The back surface 504b may have a side 508b adjacent to the back surface 504a, another side 508b opposite to a side 508a, a top side 508c, and a bottom side 508d. The housing 502a may have a pad 510a disposed on the back surface 504a proximate to the side 506a. The housing 502b may have a pad 510b disposed on the back surface 504b proximate to the side 508b.

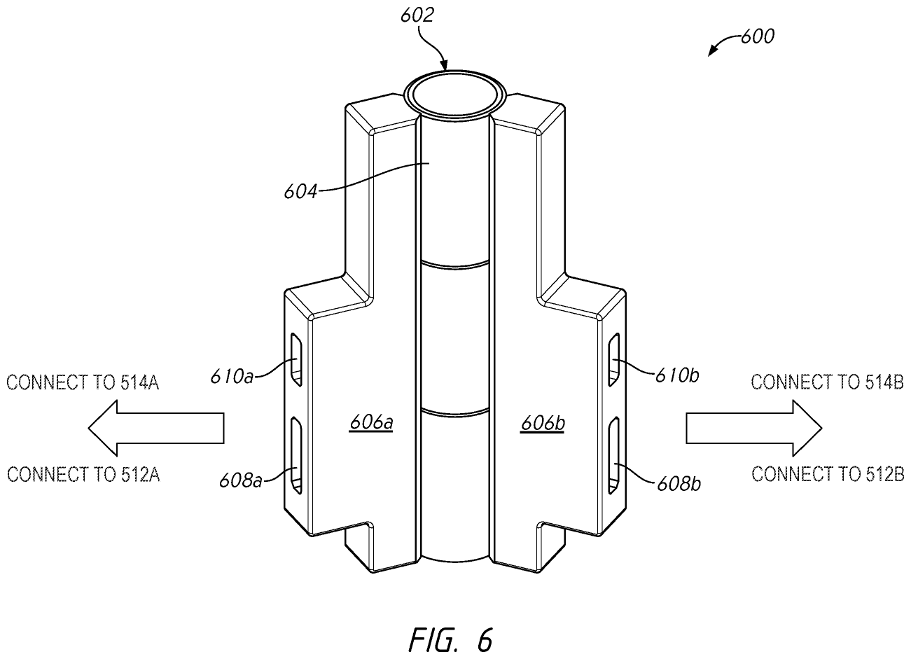

In some embodiments, the side 506a, the housing 502a, and the side 508b of the housing 502b may be securely attached to each other by a holder that is securely attached to the pads 510a and 510b, such as a holder 600 of FIG. 6 that will be described later. In some embodiments, the holder may be integrated into any of the housings 502a and 502b. In some embodiments, an electronic device, such a display, may be encased in an opening of a front surface of each of housings 502a and 502b. Thus, two adjacent docking systems including the housings 502a and 502b coupled closely may provide a seamless screen of the displays in the housings 502a and 502b.

In some embodiments, the pad 510a may include a plurality of ports, including ports 512a and 514a. The pad 510b may include a plurality of ports, including ports 512b and 514b. In some embodiments, the pads 510a and 510b may include recesses that may be the ports 512a and 514a, 512b, and 514b, respectively. Each pair of the pair of ports 512a and 512b and pair of ports 514a and 514b may be coupled by the holder, such as the holder 600. The ports 512a, 514a, 512b, 514b may receive plugs of connectors in the holder. In some embodiments, the ports 512a and 512b may be a combination of a power outlet and a power inlet. In some embodiments, the ports 512a and 512b coupled by the holder may provide a power supply voltage from the port 512a to the port 512b or vice versa. In some embodiments, the pair of ports 512a and 512b and the pair of ports 514a and 514b may be data input/output ports. In some embodiments, each of the pair of ports 512a and 512b and the pair of ports 514a and 514b coupled by the holder may transmit one or more data signals between electronic devices encased in the housings 502a and 502b in a bidirectional manner. The data signals may include, for example, a video signal, an audio signal, and/or a control signal. In some embodiments, each of the pair of ports 512a and 512b and the pair of ports 514a and 514b may transmit power and data both. For example, each of the pair of ports 512a and 512b and the pair of ports 514a and 514b may be compliant with High-Definition Multimedia Interface (HDMI), Universal Serial Bus (USB) Type-A, USB Type-B, USB Type-C, DisplayPort (DP), mini DP, etc. In some embodiments, the pair of ports 512a and 512b and the pair of ports 514a and 514b may be compliant with different standards. For example, the pair of ports 512a and 512b may be compliant with the HDMI and the pair of ports 514a and 514b may be compliant with the USB Type-C. However, the combination of standards is not limited to the above combination.

FIG. 6 illustrates a perspective view of a holder 600 of an exemplary docking system according to the embodiment of the present disclosure. The holder 600 has a hinge structure including leaves 606a and 606b and a knuckle 604 that includes a portion of the leaf 606a and a portion of the leaf 606b at a joint of the hinge structure through which a hinge pin 602 is passed. The holder 600 may pivotally adjust an angle between the leaves 606a and 606b. When the leaves 606a and 606b may be securely attached to the pads 510a and 510b, the holder 600 may securely hold the side 506a of the housing 502a and the side 508b of the housing 502b, in a manner that the angle between the housings 502a and 502b may be flexibly adjusted.

In some embodiments, each leaf of the leaves 606a and 606b may include a protuberance. In some embodiments, each of the pads 510a and 510b in FIG. 5 may be configured to securely receive the protuberance of each of the leaves 606a and 606b, respectively. In some embodiments, each of the pads 510a and 510b in FIG. 5 may include a recess that may receive the protuberance of the leaves 606a and 606b in a manner that the protuberance of each of the leaves 606a and 606b may be fitted into the recess of each of the pads 510a and 510b.

In some embodiments, the protuberance of each of the leaves 606a and 606b may include a piece of magnet and each of the pads 510a and 510b in FIG. 5 may include metal. Attraction between the piece of magnet in the protuberance of each of the leaves 606a and 606b and each of the pads 510a and 510b may further support securely attaching the housing 502b to the housing 502a.

In some embodiments, each of the leaves 606a and 606b may further include one or more pins and each of the pads 510a and 510b may include corresponding one or more holes to receive the one or more pins. In some embodiments, each of the pads 510a and 510b may include one or more pins and each of the leaves 606a and 606b may include corresponding one or more holes to receive the one or more pins. The one or more pins and the corresponding one or more holes may further support securely attaching the housing 502b to the housing 502a.

In some embodiments, the protuberance of each of the leaves 606a and 606b may include one or more plugs. In some embodiments, the leaf 606a may include a connector 608a and a connector 610a, and the leaf 606b may include a connector 608b and a connector 610b. In some embodiments, the connector 608a and the connector 610a may be connected to the ports 512a and 514a of the housing 502a in FIG. 5, and the connector 608b and the connector 610b may be connected to the ports 512b and 514b of the housing 502b in FIG. 5, respectively.

In some embodiments, any of the connectors may be a power plug and the port may be a power outlet or a power inlet. In some embodiments, the ports 512a and 512b may be a combination of a power outlet and a power inlet, coupled to the connectors 608a and 608b, respectively, and may provide a power supply voltage from the port 512a to the port 512b through the connectors 608a and 608b or vice versa. In some embodiments, the pair of connectors 608a and 608b and the pair of connectors 610a and 610b may be data connectors. In some embodiments, each of the pair of ports 512a and 512b and the pair of ports 514a and 514b coupled by each of the pair of connectors 608a and 608b and the pair of connectors 610a and 610b may transmit one or more data signals between electronic devices coupled to each of the pair of ports 512a and 512b and the pair of ports 514a and 514b in a bidirectional manner. The data signals may include a video signal, an audio signal, and/or a control signal. In some embodiments, each of the pair of connectors 608a and 608b and the pair of connectors 610a and 610b may transmit power and data both. For example, each of the pair of connectors 608a and 608b and the pair of connectors 610a and 610b may be compliant with High-Definition Multimedia Interface (HDMI), Universal Serial Bus (USB) Type-A, USB Type-B, USB Type-C, DisplayPort (DP), mini DP, etc. In some embodiments, the pair of connectors 608a and 608b and the pair of connectors 610a and 610b may be compliant with different standards. For example, the pair of connectors 608a and 608b may be compliant with the HDMI and the pair of connectors 610a and 610b may be compliant with the USB Type-C. However, the combination of standards is not limited to the above combination.

In the above example of FIGS. 5 and 6, two adjacent devices in the housings 502a and 502b are coupled to each other. However, the number of devices to be coupled is not limited. In some embodiments, another housing (not shown) adjacent to the side 506b may be further coupled to the housing 502a using the holder 600. Another housing (not shown) adjacent to the side 508a may be further coupled to the housing 502b using the holder 600.

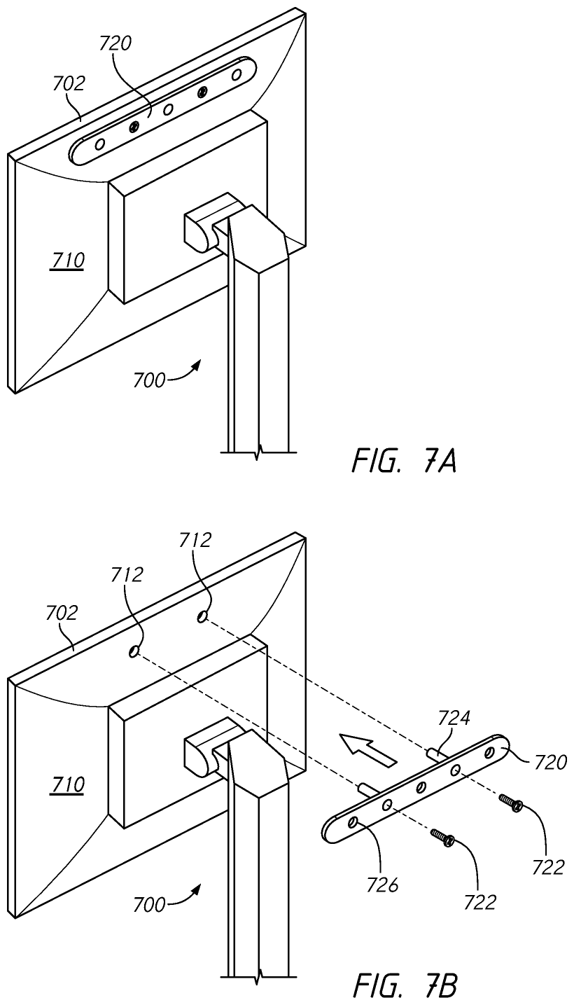

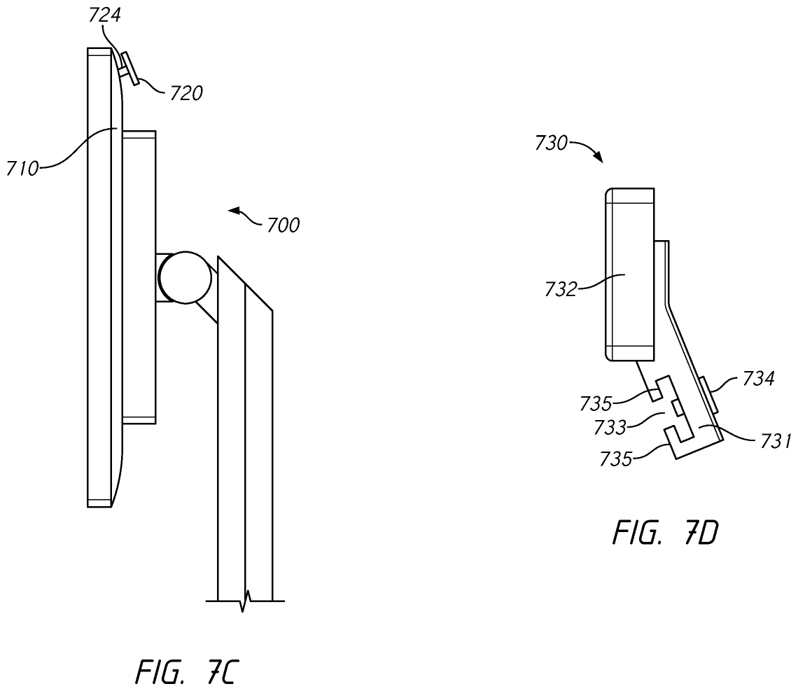

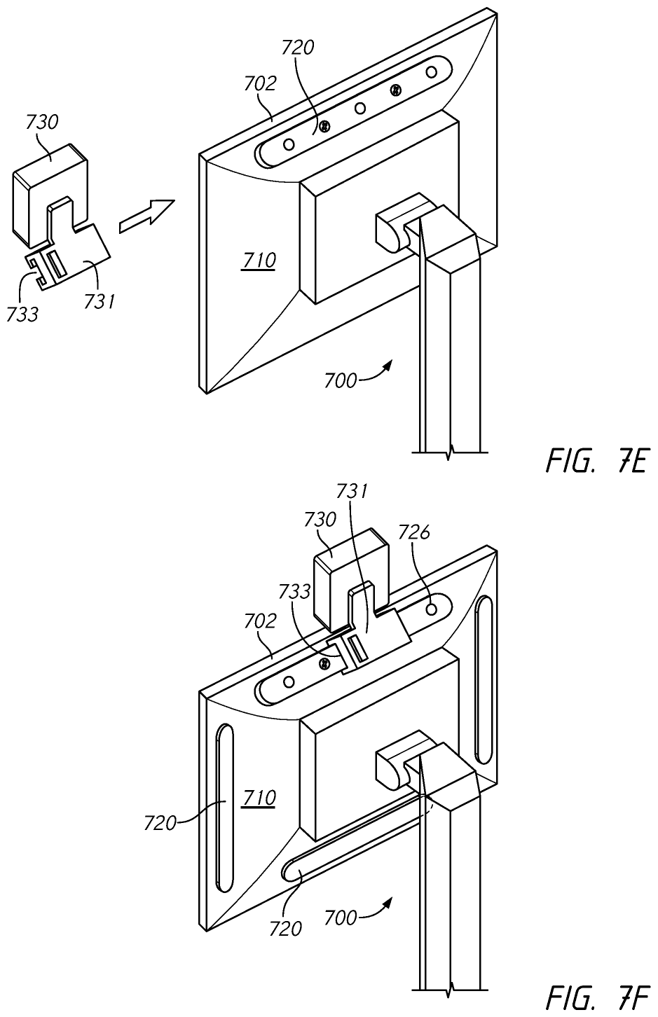

FIGS. 7A and 7B illustrate perspective views of a housing 700 according to an embodiment of the present disclosure. FIG. 7C illustrates a side view of the housing 700 according to the embodiment of the present disclosure. In some embodiments, the housing 700 may be the housing 102 of FIG. 1. Thus, detailed description of structures of the housing 700 that have been previously described referring to the housing 102 is therefore not repeated herein for brevity.

In some embodiments, the housing 700 includes a back surface 710. In some embodiments, the back surface 710 may have a rectangle shape. The housing 700 may have a pad 720 detachably attached on the back surface 710 proximate to a side 702 of the back surface 710 in FIGS. 7A and 7B. However, the pad 720 may be attached to the back surface 710 proximate to any side of the back surface 710.

In some embodiments, the housing 700 may include one or more holes 712 along the side 702. The pad 720 may include a plurality of holes 726. One or more screws 722 through one or more holes of the plurality of holes 726 and the one or more holes 712 may attach the pad 720 to the back surface 710 of the housing 700. In some embodiments, the one or more holes of the plurality of holes 726 may be selected in a manner that the pad 720 may be adjustably attached closer to one end of the side 702, closer to the other end of the side 702, or closer to the middle of the side 702.

In some embodiments, the pad 720 may include one or more separators 724 on a surface facing the back surface 710. The one or more separators 724 may provide a gap between the pad 720 and the back surface 710 when the pad 720 is attached to the back surface 710.

FIG. 7D illustrates a side view of a housing 730 according to an embodiment of the present disclosure. FIGS. 7E and 7F illustrate perspective views of housings 700 and 730 according to an embodiment of the present disclosure. In some embodiments, the housing 730 may include a base 732 that may accommodate an electronic device, such as an accessory device for an electronic device accommodated by the housing 700. The housing 730 may include a holder 731 that adjustably attaches the housing 730 itself to a portion of the pad 720. In some embodiments, the holder 731 may be a clamp that holds the pad 720. In some embodiments, the holder 731 may include jaws 735 and a groove 733 between the jaws 735. The groove 733 may have a width and a depth that may be configured to accommodate the pad 720 in the groove 733 in a manner that the pad 720 may fit in the groove 733. The holder 731 may slide on the pad 720 in the extending direction of the pad 720 while the holder 731 is holding the pad 720 in the groove. In some embodiments, the jaws 735 may fit in the gap created by the separators 724 of the pad 720. In some embodiments, the housing 730 may include a connector 734. The connector 734 may lock the holder 731 to the pad 720 or unlock the holder 731 from the pad 720. In some embodiments, the connector 734 may be a pin that may lock the holder 731 to the pad 720. In some embodiments, the connector 734 may be a switch which may lock the holder 731 to the pad 720 or unlock the holder 731 from the pad 720. In some embodiments, a portion of the holder 731, such as the connector 734, may include a magnetic piece that may be attracted to a plate of the pad 720. In some embodiments, the plate of the pad 720 may include metal, such as ferromagnetic metal. Any combination of the groove 733, the connector 734 or the magnetic piece in the holder 731 may secure the holder 731 to the pad 720 in a stable manner, regardless of the extending direction of the pad 720, whether it is horizontal or vertical.

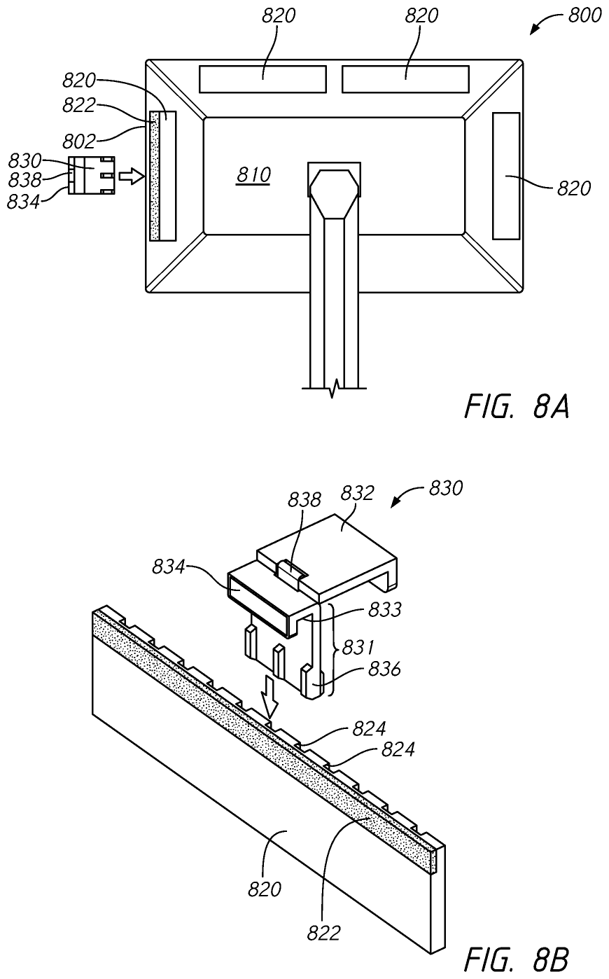

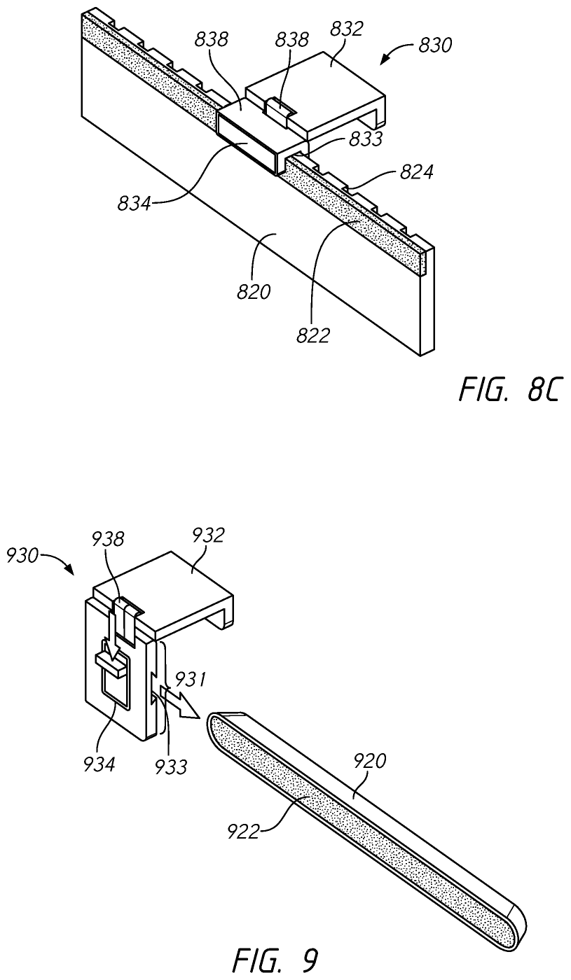

FIG. 8A illustrates a back view of a housing 800 and a housing 830 according to an embodiment of the present disclosure. FIGS. 8B and 8C illustrate the housing 830 and a pad 820 according to the embodiment of the present disclosure.

In some embodiments, the housing 800 and the pad 820 may be the housing 700 and the pad 720 of FIGS. 7A-7C. Thus, detailed description of structures of the housing 800 and the pad 820 that have been previously described referring to the housing 700 and the pad 720 is therefore not repeated herein for brevity.

In some embodiments, the housing 800 includes a back surface 810. In some embodiments, the back surface 810 may have a rectangle shape. The pad 820 may be detachably attached to the back surface 810. In some embodiments, the pad 820 may be attached proximate to a side 802 of the back surface 810 as shown in FIG. 8A. However, the pad 820 may be attached on the back surface 810 proximate to any side of the back surface 810. In some embodiments, the pad 820 may extend in a direction along the side 802. The pad 820 may include a plate 822 extending along the side 802. In some embodiments, the plate 822 may include metal, such as ferromagnetic metal.

In some embodiments, the housing 830 may include a base 832 that may accommodate an electronic device, such as an accessory device for an electronic device accommodated by the housing 800. The housing 830 may include a holder 831 that adjustably attaches the housing 830 itself to a portion of the pad 820. The portion of the pad 820 may be closer to one end of the side 802, closer to the other end of the side 802, or closer to the middle of the side 802. In some embodiments, the holder 831 may be a clamp that holds the pad 820. In some embodiments, the holder 831 may include a groove 833 that may slide on the pad 820 along the side 802 in the extending direction of the pad 820.

In some embodiments, the holder 831 may include a convex portion 836. In some embodiments, a portion of the holder 831 including the convex portion 836 may be inserted into the gap created by separators of the pad 820, such as the one or more separators 724 of FIG. 7B. The pad 820 may include one or more concave portions 824 in the gap created by the separators along the side 802. In some embodiments, the one or more concave portions 824 may be disposed at same intervals. Each of the one or more concave portions 824 may receive the convex portion 836. The convex portion 836 and the one or more concave portions may align the housing 830 with respect to the pad 820 in a stable manner, regardless of the extending direction of the pad, whether it is horizontal or vertical.

In some embodiments, the holder 831 may include a magnetic piece 834 that may be attracted to the plate 822 of the pad 820. The housing 830 may further include a hinge 838 that may pivotally adjust an angle between the base 832 and the holder 831, thus may adjustably control the angle between the electronic device in the housing 800 and the accessory device in the housing 830.

FIG. 9 illustrates a housing 930 and a pad 920 according to an embodiment of the present disclosure. In some embodiments, the pad 920 may be a pad 720 of FIG. 7A. Thus, detailed description of structures of the housing 920 that have been previously described referring to the pad 720 is therefore not repeated herein for brevity. The pad 920 may include a plate 922. The pad 920 may extend along a side, such as the side 720. In some embodiments, the plate 922 may include metal, such as ferromagnetic metal.

In some embodiments, the housing 930 may include a base 932 that may accommodate an electronic device, such as an accessory device for an electronic device accommodated by the housing 800. The housing 930 may include a holder 931 that adjustably attaches the housing 930 itself to a portion of the pad 920. In some embodiments, the holder 931 may include a groove 933 that may slide on the pad 920 along the side in the extending direction of the pad 920.

In some embodiments, the holder 931 may include a switch 934. The switch 934 may include a magnetic piece that may be attracted to the plate 922 of the pad 920. In order to move the housing 930 with respect to the pad 920, the switch 934 may be pushed away from the plate 922 to weaken the attraction between the switch 934 and the plate 922, thus the housing 930 may slide smoothly along the pad 920.

The housing 930 may further include a hinge 938 that may pivotally adjust an angle between the base 932 and the holder 931, thus may adjustably control the angle between an electronic device in a housing attached to the pad 920 and an accessory device attached to the housing 930.

As described above, two or more adjacent housings may be closely coupled to one other by a holder to provide a close connection of adjacent electronic devices encased in the housings of docking systems. For example, a close connection of adjacent displays may provide a seamless extended screen without redundant cables and wires around the devices obstructing the view.

In the manner described above, a docking system including a housing and a holder may provide secure and adjustable attachments and connections of multiple devices, such as a display device and an auxiliary device, or multiple display devices. A housing encasing an electronic device with a pad proximate to a side adjacent to another device to be coupled together with a holder provides secure attachment of the devices. A holder with a hinge structure may flexibly adjust an angle between the multiple devices while securely coupling the devices. The holder with plugs and the pad with ports may provide electrical and physical coupling of the devices without redundant cables and wires around the devices.

From the foregoing it will be appreciated that, although specific embodiments of the disclosure have been described herein for purposes of illustration, various modifications may be made without deviating from the spirit and scope of the disclosure. Accordingly, the scope of the disclosure should not be limited any of the specific embodiments described herein.

What is claimed is:

1. A docking system comprising:
a first housing comprising:
a first surface configured to receive a first device;
a second surface opposite to the first surface; and
a pad disposed on the second surface at proximity to a side of the second surface;
a port hub comprising:
a power inlet configured to receive a power supply voltage and further configured to provide the power supply voltage to the first device; and
a data input/output port configured to receive data signals and further configured to provide the received data signals to the first device; and
a holder configured to secure a second housing to the pad, the holder comprising a hinge configured to pivotally adjust an angle between the first housing and the second housing,
wherein the second housing is configured to receive a second device.

2. The docking system of claim 1, wherein the second housing further comprises the holder.

3. The docking system of claim 1, wherein either the holder or the pad comprises a pin, and
either the pad or the holder comprises a hole configured to securely receive the pin.

4. The docking system of claim 1, wherein the holder comprises a protuberance, and
wherein the pad is configured to securely receive the protuberance.

5. The docking system of claim 4, wherein the protuberance is a first protuberance,
wherein the holder further comprises a second protuberance, and
wherein the second housing is further configured to securely receive the second protuberance.

6. The docking system of claim 4, wherein the protuberance comprises a plug, and
wherein the pad comprises a port configured to receive the plug.

7. The docking system of claim 6, wherein the port and the plug are configured to provide the power supply voltage.

8. The docking system of claim 6, wherein the port and the plug are configured to provide the data signals.

9. The docking system of claim 8, wherein the data signals comprise a video signal, an audio signal, or a control signal.

10. The docking system of claim 9, wherein at least one of the first device or the second device is a display device.

11. An apparatus comprising:
a first housing comprising:
a first surface configured to receive a first device; and
a second surface opposite to the first surface;
a pad disposed on the second surface at proximity to a side of the second surface; and
a holder configured to secure a second housing to the pad,
wherein the second housing is configured to receive a second device.

12. The apparatus of claim 11, wherein the pad is configured to be detachably attached to the second surface.

13. The apparatus of claim 11, wherein the holder comprises a clamp configured to hold the pad.

14. The docking system of claim 11, wherein the second housing comprises the holder.

15. The docking system of claim 11, wherein the pad extends in a side direction along the side, and
wherein the holder is configured to attach to a portion of the pad.

16. The apparatus of claim 15, wherein the holder comprises a groove configured to securely hold the pad, and
wherein the holder is configured to slide on the pad along the side in the extending direction of the pad.

17. The apparatus of claim 15, wherein the holder further comprises a convex portion,
wherein the pad comprises one or more concave portions aligned along the side, and
wherein each concave portion of the one or more concave portions is configured to securely receive the convex portion.

18. The docking system of claim 11, wherein the holder comprises a magnetic piece configured to attach to the portion of the pad.

19. The docking system of claim 18, wherein the pad comprises metal.

20. The apparatus of claim 18, wherein the holder further comprises a switch comprising the magnetic piece,
wherein the switch is configured position the magnetic piece closer to the pad when the switch is engaged, and
wherein the switch is configured to position the magnetic piece away from the pad when the switch is released.

21. A connector device comprising:
a first plug configured to connect to a port of a first device;
a second plug configured to connect to a port of a second device; and
a hinge configured to pivotally adjust an angle between the first device and the second device,
wherein at least one of the first device or the second device is a display device.

22. The connector device of claim 21, wherein the first plug and the second plug are configured to provide a power supply voltage.

23. The connector device of claim 21, wherein the first plug and the second plug are configured to provide data signals.

24. The connector device of claim 23, wherein the data signals comprise a video signal, an audio signal, or a control signal.

25. A docking system comprising:
a base comprising a charger configured to charge a first external device;
an arm on the base;
a housing attached to the arm, configured to receive a display device; and
a port hub attached to the arm, comprising:
a power inlet configured to receive a power supply voltage and further configured to provide the power supply voltage to the display device; and
a data input/output port configured to receive data signals and further configured to provide the received data signals to the display device,
wherein the housing is configured to be securely attached to a second external device.

26. The docking system of claim 25, wherein the second external device is any of a light emitting device, a camera, a microphone, a speaker, or any combination thereof.

27. The docking system of claim 25, wherein the port hub comprises either a port compliant with any of Universal Serial Bus (USB) Type-A, USB Type-B, USB Type-C, DisplayPort (DP) or mini DP, or an audio port.

28. The docking system of claim 25, wherein the port hub is integrated into a side of the arm.

29. The docking system of claim 28, further comprising one or more sensors integrated into another side of the arm.

30. The docking system of claim 25, further comprising:
a pad disposed at proximity to a side of the housing, wherein the pad is configured to be securely attached to the second external device.

31. The docking system of claim 25, further comprising a holder configured to secure the second external device to the housing.

32. The docking system of claim 25, wherein the holder comprises a hinge configured to pivotally adjust an angle between the housing and the second external device.
